(19) United States
(12) Patent Application Publication
(10) Pub. No.: US 2008/0262757 A1
(43) Pub. Date: Oct. 23, 2008

(54) Leakage detection system

(75) Inventors: Koichi Yokosawa, Sapporo (JP); Sadaki Nakano, Kokubunji (JP); Kazuo Saitoh, Kodaira (JP)

Correspondence Address: REED SMITH LLP, Suite 1400, 3110 Fairview Park Drive, Falls Church, VA, 22042, US

(73) Assignee: Hitachi, Ltd.

(21) Appl. No.: 12/081,348

(22) Filed: Apr. 15, 2008

(30) Foreign Application Priority Data
Apr. 20, 2007 (JP) 2007-111641

(51) Int. Cl. G01M 3/04

(52) U.S. Cl. 702/51

(57) ABSTRACT

In a leakage detection system configured by arranging a number of gas sensors, a leakage spot is promptly and accurately estimated. An output voltage of the each sensor is converted into concentration, and a time differential coefficient of the concentration is obtained. A leakage spot is estimated to be on a straight line connecting between the sensors for which the time differential coefficient is large.

### CLAIM OF PRIORITY

The present application claims priority from Japanese application JP 2007-111641 filed on Apr. 20, 2007, the content of which is hereby incorporated by reference into this application.

### BACKGROUND OF THE INVENTION

1. Field of the Invention

The present invention relates to a leakage detection system for detecting gas leakage, and more particularly to a leakage detection system capable of specifying a gas leakage spot.

2. Background Art

There are various kinds of gas sensors. For example, as for combustible gas sensors, there are known, as described in JIS M7626 “a stationary type combustible gas detecting and alarming device”, sensors of a contact combustion type, a semiconductor type, a thermal conduction type, an infrared resonance type, and the like. Further, as a method using a thin film or a thick film, there are proposed an FET (Field Effect Transistor) method which is described in Sensors and Actuators, Vol. B1, pp. 15 to 20, and in which a gas sensing film is film-formed on the gate electrode, and a change in the gate potential due to a target gas is read by the FET, and a thermoelectric method which is described in Japanese Journal of Applied Physics Vol. 40, pp. L1232 to 1234, and in which a temperature rise in a thermoelectric conversion film due to a target gas is read as a voltage. The above described examples relate to single sensors. As an example using a plurality of sensors, there is disclosed, in JP Patent Publication (Kokai) No. 2002-357576, a method for detecting hydrogen gas in a wide range of hydrogen concentration by using a plurality of sensors, each of which has a different output linear area with respect to the hydrogen concentration. A technique for monitoring gas concentration distribution by linking a plurality of gas sensors via wireless communication, is described, for example, in the 10th International Meeting on Chemical Sensors, Technical Digest, pp. 94 to 95. In the example, it is proposed to configure a system for monitoring malodor and VOC in a wastewater treatment plant, a refuse disposal plant, a livestock barn, a clean room, and the like, by employing hybrid configuration of several kinds of sensors, such as an electrochemical sensor and a photoionization sensor.

Nonpatent document 1: Sensors and Actuators, Vol. B1, pp. 15 to 20

Nonpatent document 2: Japanese Journal of Applied Physics Vol. 40, pp. L1232 to 1234

Nonpatent document 3: The 10th International Meeting on Chemical Sensors, Technical Digest, pp. 94 to 95

Patent Document 1: JP Patent Publication (Kokai) No. 2002-357576

### SUMMARY OF THE INVENTION

A gas detection system which not only measures gas concentration in a specific position but also measures gas concentration distribution of the whole facility, and which performs, by using the measured results, gas leakage diffusion monitoring, and processing for specifying the leakage spot, is expected to be widely used in the future. A hydrogen station for supplying hydrogen gas to a fuel cell vehicle (FCV) is a good example of the facility requiring such gas detection system, because the hydrogen station is built in an urban area, and high safety is required for the hydrogen station.

When a leakage spot is specified by arranging several tens of sensors and by measuring gas concentration distribution, the leakage spot estimation accuracy depends on arrangement intervals of the sensors. If the gas sensors can be densely arranged (for example, at an interval of 1 m), the leakage spot can be comparatively easily specified. However, it is impossible to three-dimensionally arrange the gas sensors at the interval of 1 m in the hydrogen station site. For example, when it is assumed that the hydrogen station has an area of 30 m square and a height of 10 m, it is practical to arrange about 100 sensors at an interval of 5 m.

Thus, the present invention is to provide, in relation to a pinhole leak which is the most typical leakage mode in the hydrogen station, a technique which is suitable for specifying a leakage spot at an early stage even when the arrangement interval of the sensors is coarse. Note that the pinhole leak means a problem that a small hole is formed due to the hydrogen embrittlement or the like of a pipe (a welded part in particular) caused by high-concentration hydrogen, and thereby the high-concentration and high-pressure gas is ejected from the small hole. In the case of the pinhole leak, the gas is considered to be linearly ejected. Therefore, the gas concentration is rapidly increased in the ejecting direction, but the gas concentration is not so rapidly increased in the vicinity of the ejecting direction.

A gas sensor has a response time. Even when the concentration of target gas surrounding the gas sensor is increased stepwise, a fixed time is required until the output voltage of the gas sensor follows the stepwise increase and becomes saturated (FIG. 1A). The response time is different in dependence upon the kind and the operation principle of the sensor, and ranges from several seconds to about 30 seconds. Actually, the concentration of target gas is not increased stepwise, but is increased with a fixed gradient. When the gradient of increase in the concentration is small, the increase in the output voltage is also naturally made slow (FIG. 1B). That is, the time differential coefficient of the gas sensor output is dependent upon two parameters of the steepness of change in the gas concentration and the gas concentration itself.

Conventionally, in the leakage detection system in which a number of gas sensors are arranged, a contour line (equal concentration line) map is obtained by converting the output of each sensor into concentration. From the map, the leakage spot is estimated, and the diffusion state is monitored. In the method, during the period of time until the respective sensors become able to follow the gas concentration change, the concentration is estimated to be lower than the actual concentration. Therefore, an accurate concentration distribution is not displayed until after the lapse of the response time of the hydrogen sensors. Further, when the sensor arrangement interval is coarse, the diffusion state of leakage gas is effectively monitored, but there may be a case where the leakage spot is not easily specified.

Therefore, the present invention proposes a method of mapping the time differential coefficient of concentration in addition to the conventional equal concentration line map. In the case of the pinhole leak, the sensor arranged in the gas ejecting direction is exposed to the gas whose concentration is not only high but also steeply changed. Therefore, when the time differential coefficient of concentration corresponding to the each sensor is mapped, the sensor arranged in the gas ejecting direction is more clearly highlighted. The gas leakage spot can be estimated to be on a line connecting between the highlighted sensors, and hence the leakage spot can be easily specified by collating the estimated leakage spot with foresight information on a pipe, and the like. Further, in the method, the leakage spot can be specified still before the output voltage of the each sensor reaches a saturation value, and hence it is possible to promptly take measures, such as a measure of stopping the leakage by closing a suitable valve.

Note that in the present invention, the mapping of the time differential coefficient is not necessarily needed, and the same effect can be obtained, when the leakage spot is estimated to be on a line connecting between the sensors for which the time differential coefficient of concentration exceeds a fixed value.

According to the present invention, sensors arranged in the gas ejecting direction can be specified in the pinhole gas leakage, and thereby the leakage spot can be estimated to be on a line connecting between the specified sensors. The leakage position can be estimated by the signal processing and mapping of the time differential coefficient of output voltage of the each sensor, before the output voltage reaches a saturation value corresponding to the concentration of the gas surrounding the sensor. Thereby, it is possible to promptly and accurately find the leakage spot.

### BRIEF DESCRIPTION OF THE DRAWINGS

FIG. 1 is a figure for explaining a time response characteristic of a gas sensor.

FIG. 2 is a schematic view in which hydrogen gas sensors are arranged in a hydrogen station.

FIG. 3 is a figure in which the time response of each sensor is shown by a simple model at the time of gas leakage.

FIG. 4 is a figure obtained by modeling the equal concentration line map at the time of gas leakage.

FIG. 5 is a figure obtained by modeling an equal time differential coefficient figure at the time of gas leakage.

FIG. 6 is another figure obtained by modeling the equal time differential coefficient figure at the time of gas leakage.

FIG. 7 is a block diagram showing a configuration of a gas detection system.

FIG. 8 is a figure showing an example of a display at the time of gas leakage.

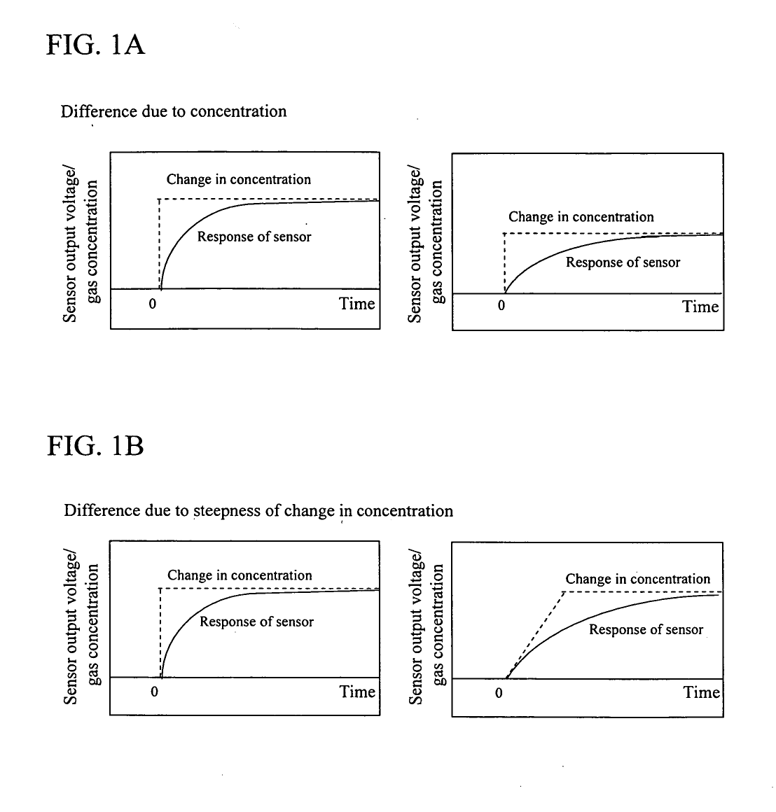

### DETAILED DESCRIPTION OF THE PREFERRED EMBODIMENTS

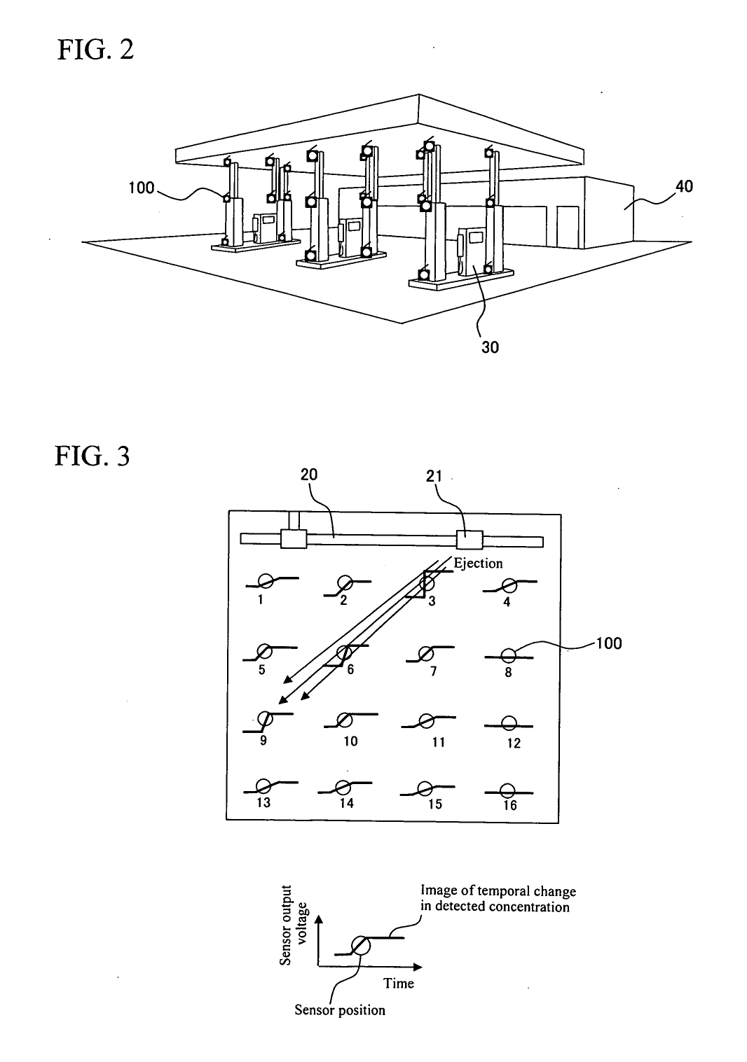

An embodiment according to the present invention will be described with reference to FIG. 2 to FIG. 8.

FIG. 2 is a schematic view showing a state in which hydrogen gas sensors are arranged in a hydrogen station. Sensors 100 are three-dimensionally arranged as shown in the figure, and are linked with a server (not shown) via wire or wireless communication. The server controls the respective sensors, and records output voltages of the respective sensors, so as to form an image of the output voltages. FIG. 2 shows an image of a group of wireless sensors. In an actual hydrogen station, the sensors are also arranged in a building 40 in which cylinder bundles for storing hydrogen and a compressor are housed, but for the sake of clarity, there is only shown the outdoor part in which dispensers 30 are installed.

FIG. 3 is a figure representing a state in which gas leakage occurs in a hydrogen station, or the like, by a very simple model. In practice, the sensors are three-dimensionally arranged as shown in FIG. 2. However, in order to facilitate explanation, a two-dimensional representation is used in the following explanation. In the figure, a round mark represents a position of a sensor 100, the number below the round mark denotes the number of the sensor, and a folding line, which is shown so as to be superposed on the round mark, schematically represents a temporal change in the sensor output voltage. It is assumed that pinhole leak occurs in a connecting section 21 of a pipe 20, and the gas is linearly ejected. At this time, the sensors No. 3, No. 6 and No. 9 are exposed to the gas at a concentration as high as nearly 100%. The gas concentration is not only high but also is temporally increased almost stepwise, and thereby the output voltage of the sensors are rapidly increased. On the other hand, the output voltages of the sensors, such as those of No. 2, No. 4, No. 5, No. 7 and No. 10, which are located slightly away from the ejecting direction, are comparatively slowly increased. The output voltages of the sensors, such as those No. 12 and No. 16, which are located further away from the ejecting direction, are hardly changed until the leaked gas is diffused.

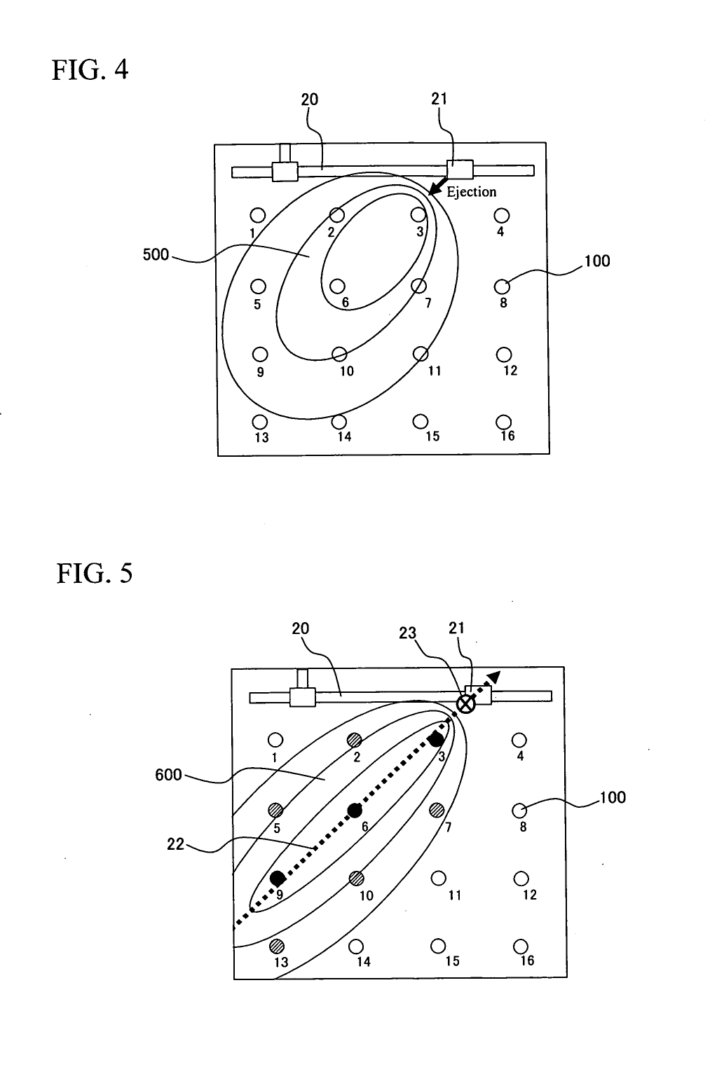

FIG. 4 is a schematic diagram in which a gas leakage state is represented by an equal concentration line distribution 500. The equal concentration line distribution diagram represents a spatial distribution of gas concentration obtained by such a way that sensor output voltages at each time are converted into concentrations, and a suitable interpolation is performed on an image of the concentrations. On the other hand, a schematic diagram shown in FIG. 5 is obtained by such a way that the sensor output voltages are converted into concentrations, and the magnitudes of the time differential coefficients of the concentrations are mapped. Each round mark showing the sensor 100 is represented by a color or density corresponding to the magnitude of the time differential coefficient. The time differential coefficient is, as described above, dependent upon both the concentration of the gas to which each sensor is exposed, and the steepness of increase in the concentration. Thus, the time differential coefficients of the sensors No. 3, No. 6 and No. 9, which are located in the gas ejecting direction, are increased. As a result, the sensors No. 3, No. 6 and No. 9 are particularly highlighted in the equal time differential coefficient diagram 600. Then, by connecting between the sensors having large time differential coefficients with a straight line 22, a leakage spot 23 is estimated to be on the straight line 22. In the actual hydrogen station, and the like, places where the leakage is liable to occur, such as pipes and connecting sections of the pipes, are generally known beforehand. Therefore, the leakage spot can be easily specified in a short time, by narrowing down the places where the leakage is liable to occur, on the basis of the straight line obtained by using the time differential coefficients.

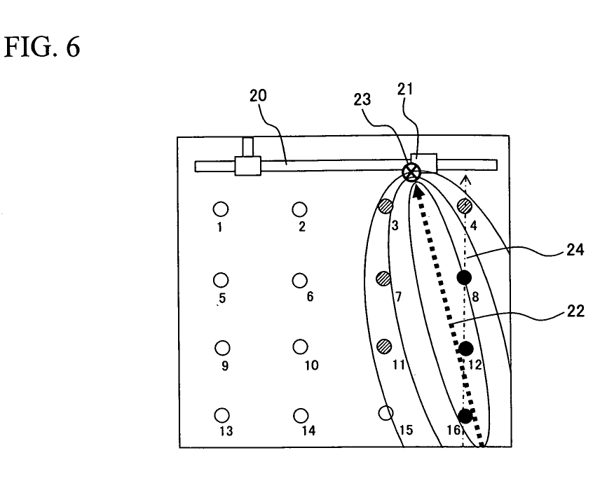

In FIG. 5, there is shown the case where a plurality of sensors are arranged in the gas leakage direction. However, as shown in FIG. 6, it is also assumed a case where the sensors are not linearly arranged in the leakage direction. In this case, the sensors No. 8, No. 12 and No. 16 are highlighted. When the highlighted sensors are connected to each other by a straight line, the leakage spot is estimated to be in the direction as indicated by a broken dotted line 24. However, in consideration of the fact that the time differential coefficient of the sensor of No. 4, which is to be most strongly highlighted in this case, is comparatively small, and that the time differential coefficients of the sensors, such as those No. 3, No. 7 and No. 11 are large as compared with the time differential coefficient of the sensor of No. 4, it is possible to correct the estimated direction to the direction as indicated by the broken dotted line 22. The straight line can be obtained by a mathematical method in which, for example, when a straight line is assumed in a space, and when the minimum distance between each sensor and the straight line is set as rᵢ, and a time differential coefficient of an output of the each sensor at a certain moment is set as Qᵢ, the position of the straight line is defined so as to minimize the total sum of Qᵢ·rᵢ for all the sensors as shown in the following formula.

$${\sum }_{i} {Q}_{i} \cdot {r}_{i}$$

The estimation of leakage spot needs to be performed during a time period while the gas leakage occurs and the gas concentration is increased, and hence only the case where Qᵢ is positive needs to be considered. By collecting information on the obtained straight line and on the places where the leakage is liable to occur, it is possible to specify the leakage spot in the same manner as described above.

Note that in FIG. 5 and FIG. 6, the two-dimensional representation is used for the sake of simplicity. For this reason, the equal value line distribution of time differential coefficients is illustrated in FIG. 5 and FIG. 6. However, since the sensors are three-dimensionally arranged in the actual leakage detection value system, the equal value surface of time differential coefficients is mapped and displayed. However, the mapping as shown in the figures is not necessarily needed in order to specify the leakage spot. It is preferred that the mapping is performed, because the mapping is effective to visually grasp the leakage spot. However, it is possible to specify the leakage spot by such a way that the straight line connecting between the sensors for which the time differential coefficient of gas concentration is a preset value or more, or the straight line obtained by minimizing the total sum of Qᵢ·rᵢ for all the sensors, and the spatial coordinates of places where the leakage is liable to occur, are collated with each other in the signal processing performed by the server.

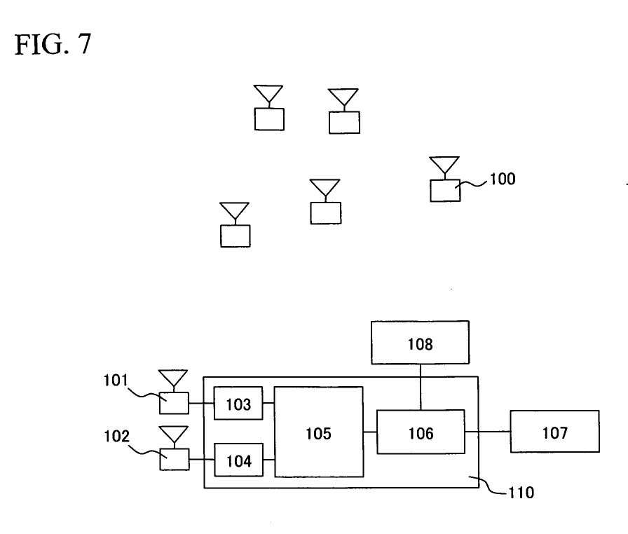

FIG. 7 is a figure showing a configuration of a gas leakage detection system. A number of sensors 100 are linked to a server 110 by wireless communication. A transmitter 101 and a receiver 102 are connected to the server. Further, a data storage 107 for storing information on pipes, places where the leakage is liable to occur and the like, and a display unit 108 are connected to the server. A calculation unit 106, a main control unit 105, a transmitter control unit 103, and a receiver control unit 104 are provided in the server.

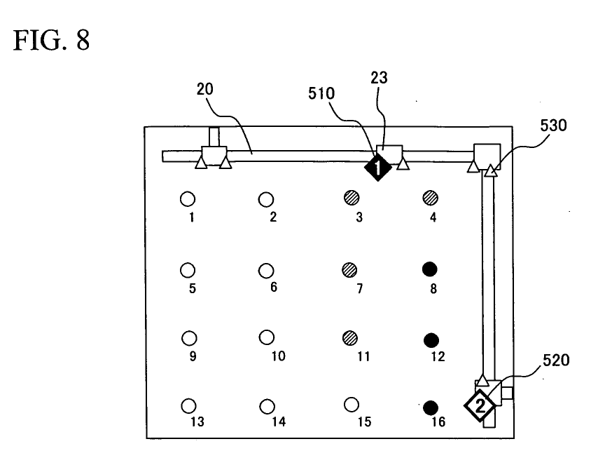

FIG. 8 shows an example of a screen display for warning the leakage. A state of a pipe is illustrated in the screen, and places where the leakage is liable to occur are shown beforehand by small triangles 530. When the leakage occurs, the straight line on which the leakage spot is estimated, and the places where the leakage is liable to occur, are collated with each other, as described above. In FIG. 8, a place with the highest possibility of leakage is displayed by a black rhomboid 510, and a place having the second highest possibility of leakage is displayed by a white rhomboid, respectively along with the number representing the order of leakage possibility. It is possible for the operator to promptly take suitable measures, such as the closing of a valve, and the starting of a diffusion fan, according to the display.

Note that figures in which the sensors and the gas pipes are two-dimensionally displayed, are shown in FIG. 4, FIG. 5, FIG. 6 and FIG. 8. However, it is preferred that the sensors and the gas pipes are three-dimensionally displayed so that the installation states of the sensors and the pipes can be accurately recognized.

What is claimed is:

1. A leakage detection system comprising:
means for collecting in real time, measured values of a plurality of gas sensors which are three-dimensionally arranged at a distance from each other; and
calculation means for processing the plurality of collected measured values,
wherein the calculation means calculates a time differential value of the measured value of the each gas sensor, and estimates a gas leakage position on the basis of a straight line connecting between the sensors for which the time differential value is a preset value or more, and of position information on a gas pipe.

2. The leakage detection system according to claim 1, wherein the gas sensor is a hydrogen gas sensor.

3. The leakage detection system according to claim 1, further, comprising display means, wherein the display means displays marks representing an installation position of the gas sensors, and a graphic representing an installation position of the gas pipe, displays the mark representing the installation position of the each gas sensor by a color or density corresponding to the time differential value of the value measured by the gas sensor, and displays a candidate of the estimated gas leakage position on the graphic representing the installation position of the gas pipe.

4. The leakage detection system according to claim 3, wherein the time differential values of the values measured by the respective gas sensors are displayed by equal value lines.
